(19) United States
(12) Patent Application Publication
(10) Pub. No.: US 2015/0092045 A1
(43) Pub. Date: Apr. 2, 2015

(54) Surface State Evaluation Apparatus and Surface State Evaluation Method

(71) Applicant: Kabushiki Kaisha Toshiba, Tokyo (JP)

(72) Inventors: Shingo KANAMITSU, Kanagawa-ken (JP); Hideaki SAKURAI, Kanagawa-ken (JP)

(73) Assignee: KABUSHIKI KAISHA TOSHIBA, Tokyo (JP)

(21) Appl. No.: 14/191,901

(22) Filed: Feb. 27, 2014

(30) Foreign Application Priority Data
Sep. 27, 2013 (JP) 2013-202508

(51) Int. Cl. G01B 13/00

(52) U.S. Cl. CPC G01B 13/00
USPC 348/135

(57) ABSTRACT

According to one embodiment, a surface state evaluation apparatus includes an imaging unit and a processing unit. The imaging unit is configured to image a first region and a second region of a surface of a sample. A plurality of liquid droplets are provided in the first region, and a plurality of liquid droplets are provided in the second region. The processing unit is configured to evaluate a state of the surface based on a result of comparing a first image of the first region imaged by the imaging unit and a second image of the second region imaged by the imaging unit.

### CROSS-REFERENCE TO RELATED APPLICATIONS

This application is based upon and claims the benefit of priority from Japanese Patent Application No.2013-202508, filed on Sep. 27, 2013; the entire contents of which are incorporated herein by reference.

### FIELD

Embodiments described herein relate generally to a surface state evaluation apparatus and a surface state evaluation method.

### BACKGROUND

For example, there is a surface state evaluation method in which the surface state of a sample such as a wafer, etc., is evaluated using liquid droplets. As various devices formed on the wafer are downscaled, it is desirable to locally evaluate the surface in fine regions. Simultaneously, it is desirable to perform a highly-efficient evaluation of a wide region of the wafer.

### BRIEF DESCRIPTION OF THE DRAWINGS

FIG. 1 is a schematic view showing the surface state evaluation apparatus according to the embodiment;

FIG. 2 is a schematic view showing the surface state of the sample;

FIG. 3A to FIG. 3F are schematic views showing surface states of a sample;

FIG. 4A and FIG. 4B are schematic views showing the surface state of a sample;

FIG. 5 is a schematic view showing the surface state of a sample;

FIG. 6A to FIG. 6F are schematic views showing surface states of samples;

FIG. 7 is a schematic view showing a characteristic of the surface state of the sample;

FIG. 8 is a schematic view showing another surface state evaluation apparatus according to a fifth embodiment; and

FIG. 9A and FIG. 9B are schematic cross-sectional views showing the surface state of a sample.

### DETAILED DESCRIPTION

According to one embodiment, a surface state evaluation apparatus includes an imaging unit and a processing unit. The imaging unit is configured to image a first region and a second region of a surface of a sample. A plurality of liquid droplets are provided in the first region, and a plurality of liquid droplets are provided in the second region. The processing unit is configured to evaluate a state of the surface based on a result of comparing a first image of the first region imaged by the imaging unit and a second image of the second region imaged by the imaging unit.

According to one embodiment, a surface state evaluation apparatus includes an imaging unit and a processing unit. The imaging unit is configured to image a sample having a plurality of liquid droplets formed on a surface of the sample. The processing unit is configured to process an image acquired by the imaging unit. The processing unit is configured to evaluate a state of the surface of the sample by at least one selected from comparing a density of the liquid droplets in the image to a first threshold, comparing a size of the liquid droplets in the image to a second threshold, and comparing a brightness of the image to a third threshold.

According to one embodiment, a surface state evaluation method is disclosed. The method can include imaging a first region and a second region of a surface of a sample. A plurality of liquid droplets are provided in the first region, and a plurality of liquid droplets are provided in the second region. The method can include processing to evaluate a state of the surface based on a result of comparing a first image of the first region imaged in the imaging and a second image of the second region imaged in the imaging.

According to one embodiment, a surface state evaluation method is disclosed. The method can include imaging a surface of a sample having a plurality of liquid droplets provided on the surface. The method can include processing an image imaged by the imaging. The processing unit is configured to evaluate a state of the surface by at least one selected from comparing a density of the plurality of liquid droplets in the image to a first threshold, comparing a size of the liquid droplets in the image to a second threshold, and comparing a brightness of the image to a third threshold.

Various embodiments will be described hereinafter with reference to the accompanying drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even for identical portions.

In the drawings and the specification of the application, components similar to those described in regard to a drawing thereinabove are marked with like reference numerals, and a detailed description is omitted as appropriate.

### First Embodiment

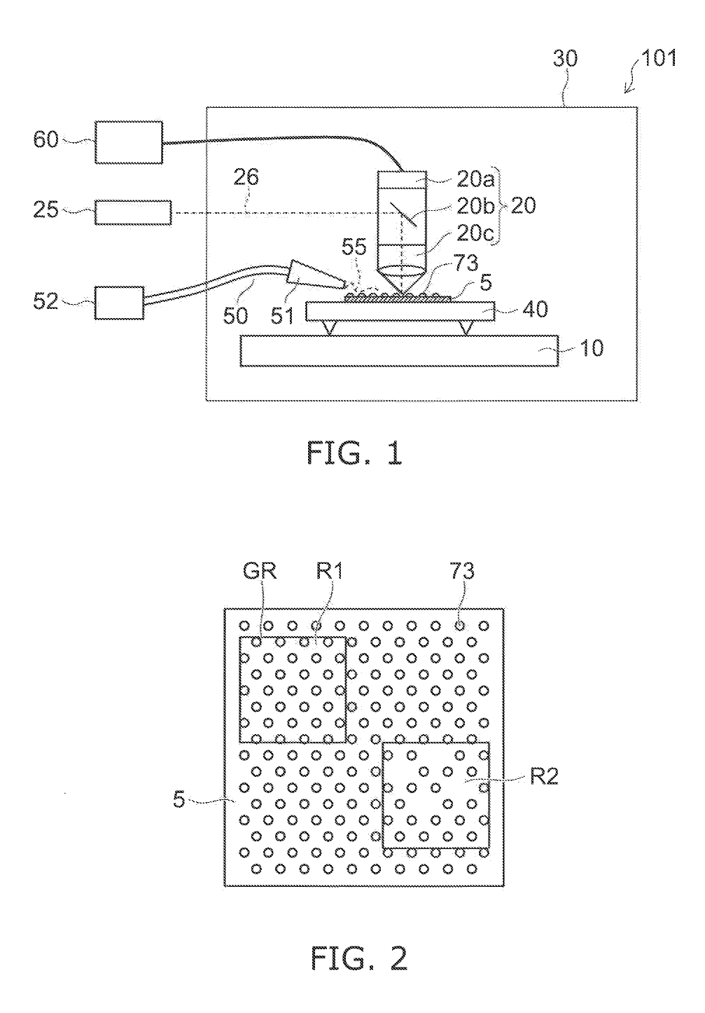

FIG. 1 is a schematic view illustrating the surface state evaluation apparatus according to the embodiment.

As shown in FIG. 1, the surface state evaluation apparatus 101 according to the first embodiment includes an imaging unit 20 and a processing unit 60. In the example, a chamber 30, a light source 25, a gas flow supply unit 50, a temperature controller 40, and a stage 10 are provided.

The imaging unit 20, the temperature controller 40, and the stage 10 are disposed, for example, inside the chamber 30.

For example, the temperature inside the chamber 30 is maintained to be constant. For example, the effect of the thermal expansion of the stage 10, etc., on the evaluation results can be reduced; and the reliability of the evaluation increases. For example, the temperature controller 40 is provided on the stage 10. A sample 5 is placed on the temperature controller 40. The sample 5 is, for example, a wafer.

The gas flow supply unit 50 supplies a gas flow 55 toward the surface of the sample 5. The gas flow 55 includes, for example, water vapor. The temperature controller 40 adjusts the temperature of the sample 5. Liquid droplets 73 are formed on the surface of the sample 5 by adjusting and operating the gas flow supply unit 50 and the temperature controller 40.

For example, a camera 20a, an optical system 20b, and an objective lens 20c are provided in the imaging unit 20. Light 26 passes through the optical system 20b and is irradiated toward the surface of the sample 5. The surface state of the sample 5 is viewed using reflected light or transmitted light of the light 26. In the example, the light 26 that is irradiated onto the surface of the sample 5 is reflected to pass through the objective lens 20c. The surface of the sample 5 is imaged by the camera 20a. For example, the stage 10 is driven in conjunction with the imaging unit 20. Thereby, the viewing of the surface of the sample 5 can be performed continuously. The processing unit 60 processes the images that are imaged.

The camera 20a includes, for example, a CCD sensor, a CMOS sensor, etc. The objective lens 20c includes, for example, a high-magnification lens having a magnification of about 300 times.

The light 26 is emitted from the light source 25. The light source 25 includes, for example, a laser light source. The light 26 is, for example, laser light. The light 26 is, for example, ultraviolet of a short wavelength. The laser light includes an ArF excimer laser, etc. The wavelength of the ArF excimer laser is about 193 nm. The resolution of the imaging can be increased by using the light 26 of the laser of the short wavelength.

For example, a nozzle 51 and an air flow apparatus 52 are provided in the gas flow supply unit 50. In the example, the air flow apparatus 52 is provided, for example, outside the chamber 30. The nozzle 51 is provided at the surface vicinity of the sample 5 inside the chamber 30. The nozzle 51 is connected to the air flow apparatus 52. The air flow apparatus makes the gas flow 55 of which the temperature and humidity are adjusted. The gas flow 55 is supplied from the nozzle 51 toward the surface of the sample 5. The humidity of the gas flow 55 and the flow rate of the gas flow 55 are adjusted to be in a desired state.

The sample 5 can be cooled by contact between the temperature controller 40 and the sample 5. The sample 5 is cooled by, for example, thermal conduction. A cooling head and a temperature sensor are provided in the temperature controller 40. The cooling head includes, for example, a Peltier device, etc. The temperature sensor includes, for example, a thermocouple, etc. The temperature of the sample 5 is adjusted to a prescribed temperature within the range of, for example, 5° C. to 30° C.

The gas flow 55 is supplied toward the surface of the sample 5 that is cooled by the temperature controller 40. The gas (the gas flow 55) that is inside the atmosphere changes to a liquid on the surface of the sample 5. For example, the water vapor inside the atmosphere is caused to condense. Thereby, the liquid droplets 73 are formed on the surface of the sample 5.

The temperature inside the chamber 30 is adjusted to, for example, 22° C. by the gas flow supply unit 50. The temperatures of the members such as the objective lens 20c that are inside the chamber 30 are set to about 22° C. Further, the temperature of the surface of the sample 5 is adjusted to, for example, 13° C. by the temperature controller 40. Thereby, the surface vicinity of the sample 5 inside the chamber 30 is maintained at a low temperature compared to the surroundings. In this state, for example, clean air (the gas flow 55) that has a humidity of 60% is caused to flow from the nozzle 51 toward the surface of the sample 5.

The saturation water vapor content at 1 atmosphere and 22° C. is 19.4 g/m³. At 13° C., the saturation water vapor content is 11.4 g/m³. For example, air having a humidity of 60% at 22° C. includes 11.64 g of water vapor. Accordingly, at such conditions, about 0.2 g of water molecules changes from a gas to a liquid. Thereby, the liquid droplets 73 are formed.

The particle size and/or density of the liquid droplets 73 depends on many parameters such as, for example, the flow rate of the air flow, the temperature gradient of the sample 5 surface, the distance between the sample 5 surface and the nozzle 51, the atmosphere, the existence or absence of particles that form nuclei, the air flow inside the chamber 30, etc. Even for the same temperature and/or humidity, the particle size and/or density of the liquid droplets 73 that are formed change when the other parameters are changed.

By adjusting the conditions of the temperature, the humidity, etc., the liquid droplets 73 start to form on the surface of the sample 5. In the initial state, the diameters of the liquid droplets 73 are, for example, about 1 nm to 10 nm. The liquid droplets 73 are unstable when the diameters are 1 nm to 10 nm. In some cases, evaporation of the liquid droplets 73 occurs frequently. In some cases, the positions of the liquid droplets 73 are unstable.

Subsequently, the diameters of the liquid droplets 73 enlarge to, for example, about 100 nm.

The liquid droplets 73 having diameters of about 100 nm are recognized using the optical system 20b. For example, the surface of the sample 5 is imaged by the imaging unit 20 in the state in which the liquid droplets 73 have diameters of about 100 nm.

FIG. 2 is a schematic view illustrating the surface state of the sample.

FIG. 2 illustrates an image of the surface of the sample 5. In the example, the field of view of the imaging is 5 μm by 5 μm. Images that include the multiple liquid droplets 73 are imaged. The diameters of the liquid droplets 73 are about 100 nm.

A measurement grid GR is set in the image illustrated in FIG. 2. For example, the number of the liquid droplets 73 inside the measurement grid GR is measured. In other words, the density of the liquid droplets 73 inside the measurement grid GR is measured. The processing unit 60 sequentially and continuously scans the regions that are subdivided by the measurement grid GR inside the image to measure the density of the liquid droplets 73 in the image of each region.

For example, the difference between the density of the liquid droplets 73 in the first image of a first region R1 and the density of the liquid droplets 73 in the second image of a second region R2 corresponds to the difference between the surface state of the sample 5 in the first region R1 and the surface state of the sample 5 in the second region R2.

The surface of the sample 5 includes the first region R1 where the multiple liquid droplets 73 are provided and the second region R2 where the multiple liquid droplets 73 are provided. The imaging unit 20 images the first region R1 and the second region R2.

The processing unit 60 compares the first image of the first region R1 and the second image of the second region R2. The processing unit 60 evaluates the state of the surface of the sample 5 based on the result of the comparison.

In the first embodiment, the surface state of the sample 5 is evaluated based on the difference between the density of the liquid droplets 73 in the first image and the density of the liquid droplets 73 in the second image.

In each of the regions, the density of the liquid droplets 73 that are provided depends on the surface state of the sample 5 in the region. A difference occurs between the densities of the liquid droplets 73 due to the hydrophilic properties of the surface of the sample 5, the hydrophobic properties of the surface of the sample 5, the ease of the adsorption of the water molecules to the surface of the sample 5, the rate of the liquid droplets 73 combining, etc. A difference occurs between the densities of the liquid droplets 73 due to the existence of a local region (a unique region) that has a surface state that is different from those of the surrounding regions.

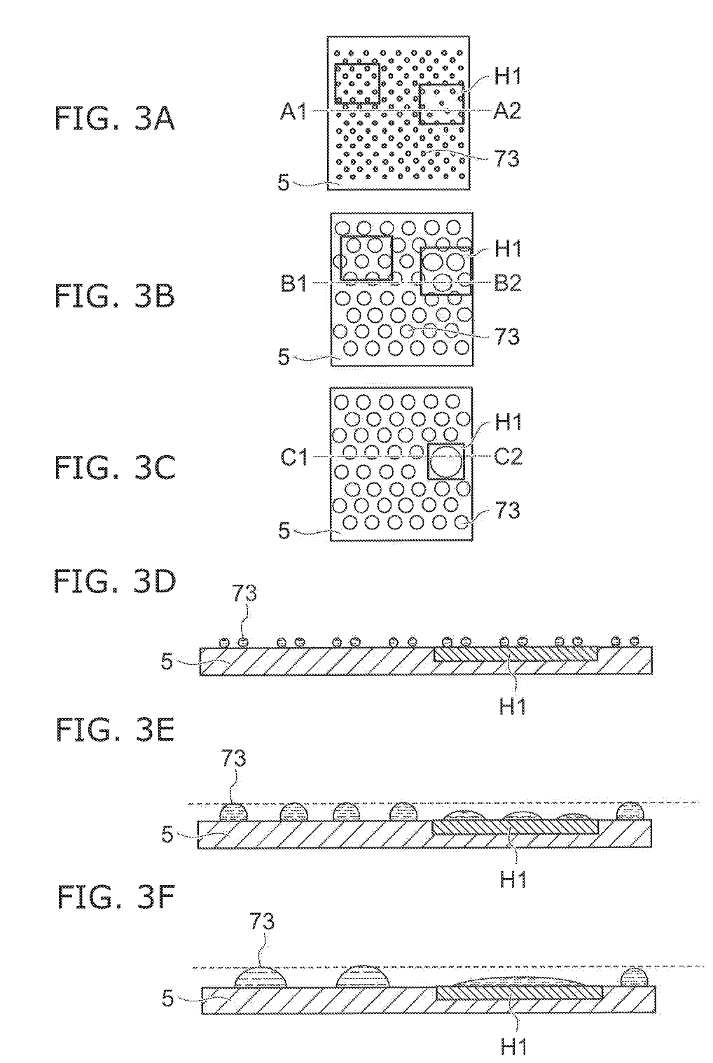

FIG. 3A to FIG. 3F are schematic views illustrating surface states of a sample.

These drawings illustrate the growth process of the liquid droplets 73 on the surface of the sample 5. For example, there is a local region (a unique region) that has a surface state that is different from those of the surrounding regions in the surface of the sample 5. In the example, a hydrophilic region H1 is a unique region in the surface of the sample 5.

FIG. 3A illustrates the surface of the sample 5 at an initial stage of the growth of the liquid droplets 73. At the initial stage of the growth of the liquid droplets 73, the water molecules adsorb to the surface of the sample 5.

FIG. 3B illustrates the surface of the sample 5 at an intermediate stage of the growth of the liquid droplets 73. At the intermediate stage of the growth of the liquid droplets 73, the diameters of the liquid droplets 73 are about 10 nm to 100 nm.

FIG. 3C illustrates the surface of the sample 5 at a later stage of the growth of the liquid droplets 73. At the later stage of the growth of the liquid droplets 73, the diameters of the liquid droplets 73 are 100 nm or more.

FIG. 3D is a schematic cross-sectional view illustrating the cross section along line A1-A2 of FIG. 3A.

FIG. 3E is a schematic cross-sectional view illustrating the cross section along line B1-B2 of FIG. 3B.

FIG. 3F is a schematic cross-sectional view illustrating the cross section along line C1-C2 of FIG. 3C.

At the initial stage of the growth of the liquid droplets 73, the liquid droplets 73 are small; and there are cases where it is difficult to identify the sizes of the liquid droplets 73. For example, in the hydrophilic region H1, the liquid droplets 73 combine with each other; and the number of the liquid droplets 73 decreases. For example, in the hydrophilic region H1, the density of the liquid droplets 73 is lower than the density of the liquid droplets 73 in the other regions.

At the intermediate stage of the liquid droplet growth, for example, the sizes of the liquid droplets 73 can be measured. For example, in the hydrophilic region H1, each of the liquid droplets 73 spreads more easily than those of the other regions. The liquid droplets 73 that spread over the plane combine with the adjacent liquid droplets 73. The contact angles between the liquid droplets 73 and the surface of the sample 5 are smaller in the hydrophilic region H1 than in the other regions. For example, the sizes of the liquid droplets 73 in the hydrophilic region H1 are greater than the sizes of the liquid droplets 73 in the other regions.

At the later stage of the liquid droplet growth, the liquid droplets 73 in the hydrophilic region H1 are even larger than the liquid droplets 73 in the other regions.

In the first embodiment, images are acquired at, for example, the initial stage to the intermediate stage of the liquid droplet growth. For example, the density of the liquid droplets 73 is measured for each region of the measurement grid GR. In the example, the density of the liquid droplets 73 is measured without measuring the size of each of the multiple liquid droplets 73. The difference between the densities of the liquid droplets 73 for the regions corresponds to the difference between the surface states for the regions of the sample 5. Unique regions of the surface of the sample 5 can be detected by comparing the densities of the liquid droplets 73 for the regions.

Other methods for measuring the state of the surface include the method of a reference example in which, for example, the contact angles of the liquid droplets with respect to the sample surface are measured. The contact angles can be measured when the liquid droplets are large. When the liquid droplets are large, the method of the reference example is employed in which each of the liquid droplets is viewed and the contact angle of each of the liquid droplets is measured. In other words, in the reference example, the liquid is large enough that the contact angle can be measured. Thus, in the reference example in which the liquid is large, for example, it is difficult to detect small unique regions. In other words, when large liquid droplets are used, the liquid droplets cover multiple fine regions having different surface states. Therefore, the average of the multiple regions is measured. In the reference example, the evaluation of fine regions is difficult. Further, much time is necessary for the measurement in the method for viewing each of the liquid droplets. In such a reference example, it is difficult to efficiently evaluate the surface state in a wide region of the sample (e.g., the wafer).

In the embodiment, by comparing the images of the surface of the sample 5 in which the liquid droplets 73 are provided, for example, the surface state can be evaluated for a wide range of regions, from regions having a size of about 1 μm to fine regions having sizes that are less than 1 μm. For example, the embodiment can be used in semiconductor processes in which downscaling has progressed. The embodiment can be used to evaluate the surface of the sample 5 for patterning technology that uses nanoimprint technology or DSA (Directed Self Assembly) instead of photolithography.

According to the embodiment, a surface state evaluation apparatus and a surface state evaluation method are provided in which the surface state of fine regions of a sample can be evaluated over a wide range.

### Second Embodiment

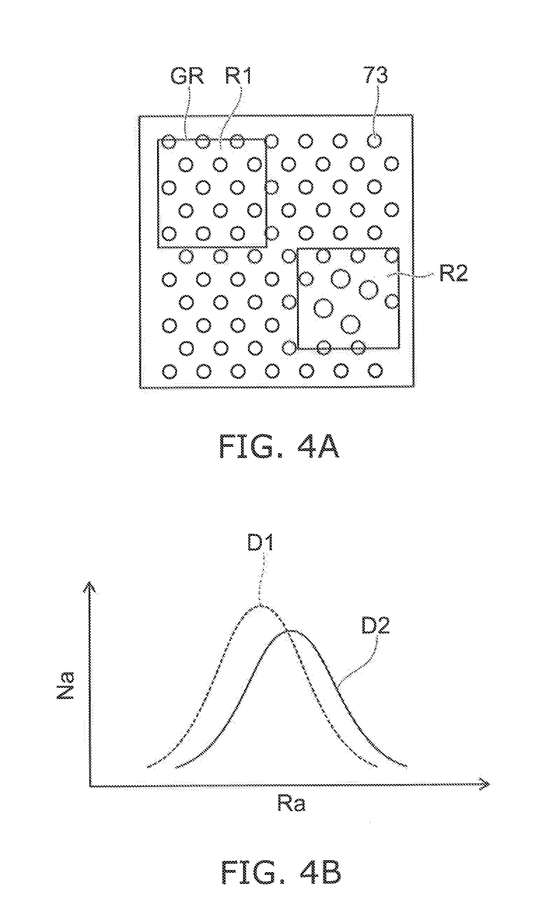

FIG. 4A and FIG. 4B are schematic views illustrating the surface state of a sample.

FIG. 4A illustrates an image of the surface of the sample 5. The field of view of the imaging is, for example, 5 μm by 5 μm. The liquid droplets 73 are provided on the surface of the sample 5. In the example, the images are acquired when the liquid droplets 73 have grown more than in the state illustrated in FIG. 2.

In FIG. 2, the diameters of the liquid droplets 73 are, for example, about 100 nm. After the liquid droplets 73 have grown to about 100 nm, the gas flow 55 that includes water vapor is further supplied toward the surface of the sample 5. Thereby, the liquid droplets 73 grow further.

On the other hand, in FIG. 4A, the diameters of the liquid droplets 73 are, for example, about 100 nm to 1 μm. When the diameters of the liquid droplets 73 are 100 nm to 1 μm, the size of each of the liquid droplets 73 can be measured.

The number of the liquid droplets 73 and the size of each of the liquid droplets 73 are measured inside the measurement grids GR illustrated in FIG. 4A. The processing unit 60 sequentially scans the regions that are subdivided by the measurement grids GR. For example, the scanning is performed continuously. The number of the liquid droplets 73 and the size of each of the liquid droplets 73 are measured for each of the regions. Thus, a histogram of the sizes of the liquid droplets 73 (the size distribution of the liquid droplets 73) can be obtained for the regions.

FIG. 4B is a schematic view illustrating the surface state of the sample.

FIG. 4B illustrates the size distributions of the liquid droplets in the first region R1 and the second region R2. The horizontal axis of FIG. 4B is a size Ra of the liquid droplets 73. The vertical axis of FIG. 4B is a number Na of the liquid droplets 73. For example, in the first region R1, there are no unique regions in the surface of the sample 5. In the second region R2, there is a unique region in the surface of the sample 5. In such a case, as shown in FIG. 4B, a difference occurs between a size distribution D1 of the liquid droplets 73 in the first region R1 and a size distribution D2 of the liquid droplets 73 in the second region R2.

The processing unit 60 evaluates the state of the surface of the sample based on the difference between the sizes of the liquid droplets 73 (the size distribution of the liquid droplets) in the first image of the first region R1 and the sizes of the liquid droplets 73 (the size distribution of the liquid droplets) in the second image of the second region R2.

For example, in the case where a region that has high hydrophilic properties exists in the surface of the second region R2, the speed of the adsorption of the water molecules to the surface of the sample increases. In the case where a region that has high hydrophilic properties exists in the surface of the second region R2, the adjacent liquid droplets 73 combine more easily. Thereby, for example, the number of the liquid droplets 73 of the surface of the sample 5 decreases; and the liquid droplets 73 become large.

The size distribution of the liquid droplets 73 is compared for the regions. Thereby, the regions of the surface of the sample 5 that have unique regions can be detected.

The stage 10 is moved according to the size of the field of view of the imaging unit 20. Images are acquired by the imaging unit 20 in conjunction with the movement of the stage 10. Thereby, a wide region of the surface of the sample 5 can be evaluated. For example, a map that displays the unique regions of the surface of the sample 5 can be made. Thereby, a surface state evaluation apparatus and a surface state evaluation method can be provided in which the surface state of fine regions of a sample can be evaluated over a wide range.

### Third Embodiment

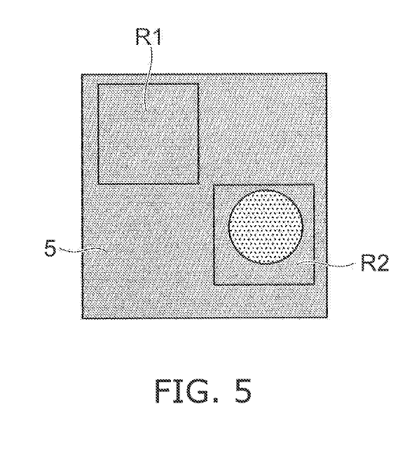

FIG. 5 is a schematic view illustrating the surface state of a sample.

FIG. 5 illustrates the distribution of the brightness (the contrast distribution) of the image of the surface of the sample 5. For example, filtering such as averaging, etc., of the image is performed. Thereby, a display of the distribution of the brightness is obtained.

For example, the difference between the brightness of the first image of the first region R1 and the brightness of the second image of the second region R2 is sensed. For example, a difference occurs between the brightness in the case where the density of the liquid droplets 73 is different from those of the surrounding regions. For example, the brightness of the image at the unique region vicinity is higher than the brightness of the surrounding regions.

For example, there is no unique region in the first region R1; and there is a unique region in the second region R2. In such a case, the density of the liquid droplets 73 in the second region R2 is, for example, less than the density of the liquid droplets 73 in the first region R1. In such a case, for example, a portion of the second region R2 is brighter than the first region R1. Thereby, the surface state of the sample can be evaluated.

The processing unit 60 evaluates the state of the surface of the sample based on the difference between the brightness of at least a portion of the first image and the brightness of at least a portion of the second image.

For example, the stage 10 is moved according to the size of the field of view of the imaging unit 20. The images are acquired by the imaging unit 20 in conjunction with the movement of the stage 10. Thereby, a wide region of the sample 5 surface can be evaluated. For example, a map that displays the unique regions of the surface of the sample 5 can be made. Thereby, sorting can be performed by determining the goodness of the sample.

### Fourth Embodiment

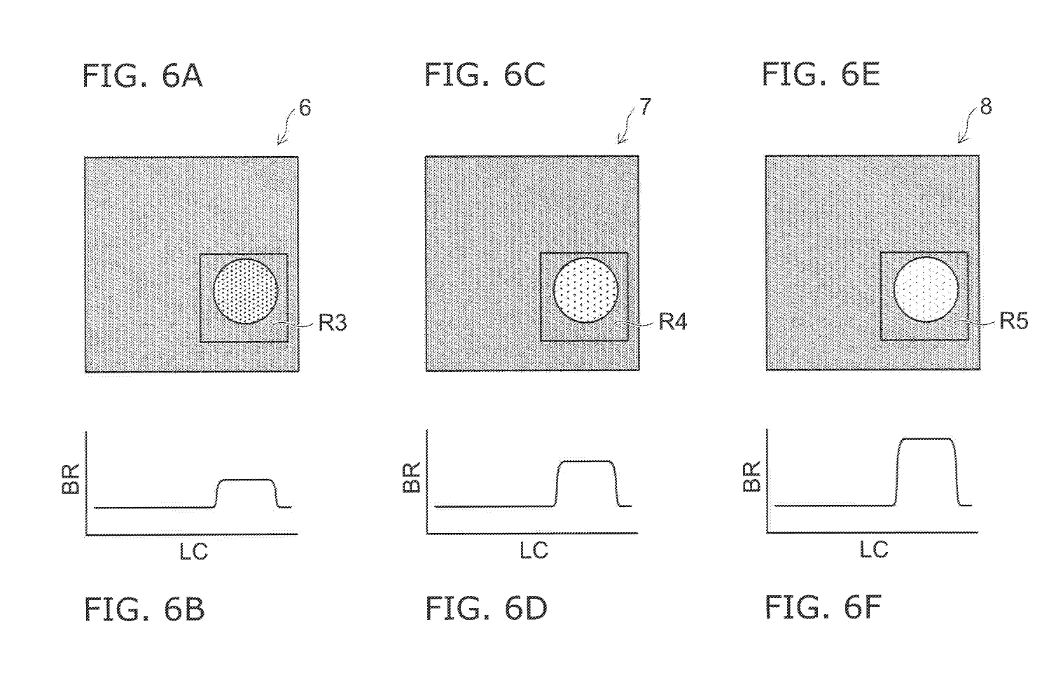

FIG. 6A to FIG. 6F are schematic views illustrating surface states of samples.

FIG. 6A, FIG. 6C, and FIG. 6E illustrate the surface images of a sample 6, a sample 7, and a sample 8, respectively. The liquid droplets 73 are provided on the surfaces of the sample 6, the sample 7, and the sample 8.

FIG. 6B, FIG. 6D, and FIG. 6F illustrate the distributions of the brightness of the images shown in FIG. 6A, FIG. 6C, and FIG. 6E, respectively.

In FIG. 6B, FIG. 6D, and FIG. 6F, the vertical axis is a brightness BR of the image, In FIG. 6B, FIG. 6D, and FIG. 6F, the horizontal axis is a position LC in the image.

For example, there are unique regions in a third region R3 of the sample 6, a fourth region R4 of the sample 7, and a fifth region R5 of the sample 8. In such a case, for example, as shown in FIG. 6B, FIG. 6D, and FIG. 6F, the image of the third region R3, the image of the fourth region R4, and the image of the fifth region R5 are bright.

For example, the hydrophilic property of the unique region of the fourth region R4 is greater than the hydrophilic property of the unique region of the third region R3. The hydrophilic property of the unique region of the fifth region R5 is greater than the hydrophilic property of the unique region of the fourth region R4. In such a case, the fourth region R4 is brighter than the third region R3. The fifth region R5 is brighter than the fourth region R4.

Thus, a difference occurs between the brightness due to the difference between the surface states. The difference between the brightness can be quantified. The surface states can be quantified using the difference between the brightness. For example, the quantified value is used as a surface state difference ΔN.

For example, a substrate (a wafer) of a semiconductor process is used as the sample. For example, a resist is coated onto the substrate; and the resist is patterned by photolithography. For example, a defect probability P of the photolithography process depends on the state of the surface of the substrate.

For example, there is a unique region having high hydrophilic properties in a portion of the substrate. In such a case, there are cases where collapse (defects) occur in the resist that is formed on the unique region. The defect probability P when using the resist process can be determined separately from the surface state difference ΔN.

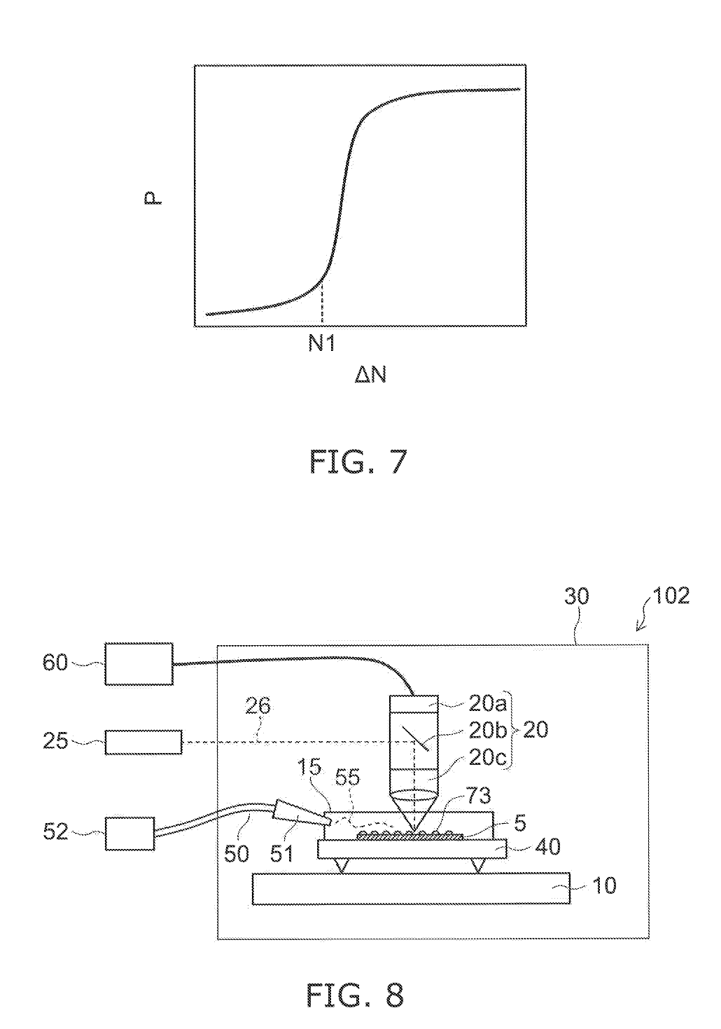

FIG. 7 is a schematic view illustrating a characteristic of the surface state of the sample.

FIG. 7 illustrates the relationship between the defect probability P and the surface state difference ΔN. The horizontal axis of FIG. 7 is the surface state difference ΔN. The vertical axis of FIG. 7 is the defect probability P. For example, the defect probability P is low when the surface state difference ΔN is small. The defect probability P increases when the surface state difference ΔN becomes large. In the example shown in FIG. 7, the defect probability P increases abruptly when the surface state difference ΔN becomes larger than a threshold N1. By using such a relationship, the defect probability P can be determined from the surface state difference ΔN. The threshold N1 is set beforehand from the relationship between the defect probability P of the sample and the images including the multiple liquid droplets 73 of the surface of the sample 5. The predetermined threshold N1 is compared to the images that are imaged. Thereby, the surface of a sample having a local unique region can be evaluated over a wide range.

For example, the threshold N1 is predetermined for the brightness of the image. The processing unit 60 evaluates the surface state of the sample by comparing the predetermined threshold N1 to the brightness of the images that are imaged.

The density of the liquid droplets 73 or the sizes of the liquid droplets 73 may be used as the surface state difference ΔN. Also, the number and/or density of the liquid droplets 73 may be used as the surface state difference ΔN by being converted into the wettability of the sample, the free energy, the unevenness of the surface of the sample 5, the OH group concentration of the surface of the sample 5, the potential of the surface of the sample 5, etc., by a simulation or the like.

According to the embodiment, a surface state evaluation apparatus and a surface state evaluation method are provided in which the surface state of fine regions of a sample can be evaluated over a wide range.

### Fifth Embodiment

FIG. 8 is a schematic view illustrating another surface state evaluation apparatus according to a fifth embodiment.

In the surface state evaluation apparatus 102, an objective lens 20c having a longer focal distance than that of the surface state evaluation apparatus 101 illustrated in FIG. 1 is used. Thereby, in the surface state evaluation apparatus 102, the distance between the objective lens 20c and the sample 5 can be lengthened.

A cover 15 that has a height that does not contact the objective lens 20c is provided to cover the sample 5. At least the upper surface of the cover 15 is made of a substance having a high transmittance of light. For example, the cover 15 includes a quartz plate. Thereby, the loss of the incident light and the reflected light can be suppressed.

For example, a temperature sensor, a humidity sensor, a compact heater, etc., are provided inside the cover 15. Thereby, the atmosphere inside the cover 15 can be controlled with higher resolution.

In the surface state evaluation apparatus 102, the gas flow 55 is supplied from the gas flow supply unit 50 when forming the liquid droplets 73 on the surface of the sample 5. The gas flow 55 includes, for example, water vapor. In such a case, for example, water is made into water vapor and the humidity of the gas is adjusted in the air flow apparatus 52. The temperature controller 40 is adjusted. Thereby, the temperature controller 40 can cause the surface of the sample 5 to be in a vapor-liquid equilibrium state in the imaging.

An atmosphere that is different from the surroundings can be created inside the cover 15. Thereby, for example, a gas that would damage hardware such as the optical system 20b, etc., can be used.

For example, the gas flow 55 may include multiple particles (nanoparticles). For example, the diameter of each of the multiple particles is not less than 1 nm and not more than 50 nm.

For example, the gas flow 55 may include a polyalcohol. In such a case, a mixture of a dihydric alcohol and water or a mixture of a trihydric alcohol and water is used in the air flow apparatus 52. The dihydric alcohol is, for example, ethylene glycol. The trihydric alcohol is, for example, glycerin. The gas including alcohol is caused to flow from the air flow apparatus 52 onto the surface of the sample 5. The liquid droplets 73 including alcohol are provided on the surface of the sample 5. The liquid droplets 73 of water including alcohol evaporate less easily than the liquid droplets 73 of water not including alcohol. Thereby, the liquid droplets 73 evaporate less easily when acquiring the images of the surface of the sample 5. For example, the surface state evaluation apparatus 102 in which the cover 15 is provided as shown in FIG. 8 is used when providing the liquid droplets 73 including alcohol.

In the initial stage in which the liquid droplets 73 are formed, the diameters of the liquid droplets 73 are about 1 nm to 10 nm. In some cases, such liquid droplets 73 are not stable thermodynamically. In some cases, the liquid droplets 73 that are formed evaporate. In some cases, the positions of the liquid droplets 73 that are formed are not stable.

Multiple particles (nanoparticles) may be coated onto the surface of the sample 5. For example, PSL (polystyrene latex) particles may be coated onto the surface of the sample. Thereby, for example, small liquid droplets 73 are stably formed. Micro PSL particles having diameters of about 20 nm may be used. For example, PSL particles having diameters of 20 nm are coated with the appropriate density onto the surface to be measured. Subsequently, the liquid droplets 73 are formed by making a gas from water or from a mixture of water and a polyalcohol and causing the gas to flow toward the surface vicinity of the sample 5.

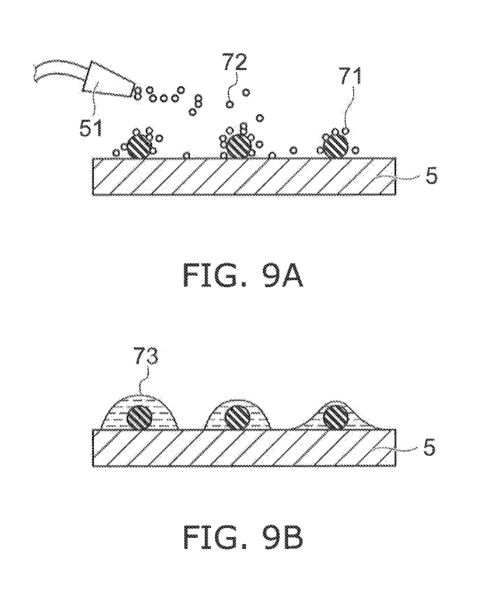

FIG. 9A and FIG. 9B are schematic cross-sectional views illustrating the surface state of a sample.

FIG. 9A and FIG. 9B illustrate the formation of the liquid droplets 73 in the case where particles 71 (e.g., PSL particles, etc.) are used.

As shown in FIG. 9A, for example, the gas flow 55 that includes water molecules 72 is supplied from the nozzle 51. The water molecules 72 that are supplied to the surface of the sample 5 are adsorbed to the surface of the sample 5. The liquid droplets 73 such as those of FIG. 9B start to form with the particles 71 as nuclei. Subsequently, the diameters of the liquid droplets 73 grow to about 10 nm. The liquid droplets 73 are more stable when the particles 71 are used than when the particles 71 are not used. The liquid droplets 73 having diameters of about 10 nm can be viewed by the surface state evaluation apparatus.

After the evaluation ends, for example, the moisture is caused to evaporate from the sample surface; and ultraviolet light is irradiated. Thereby, the particles 71 can be removed. The inspection can be performed without contaminating the sample. According to the embodiment, stable liquid droplets 73 can be formed on the sample surface.

According to the embodiment, a surface state evaluation apparatus and a surface state evaluation method are provided in which the surface state of fine regions of a sample can be evaluated over a wide range.

Hereinabove, exemplary embodiments of the invention are described with reference to specific examples. However, the invention is not limited to these specific examples. For example, one skilled in the art may similarly practice the invention by appropriately selecting specific configurations of components such as the imaging unit, the processing unit, the gas flow supply unit, the temperature controller, etc., from known art; and such practice is within the scope of the invention to the extent that similar effects are obtained.

Further, any two or more components of the specific examples may be combined within the extent of technical feasibility and are included in the scope of the invention to the extent that the purport of the invention is included.

Moreover, all surface state evaluation apparatuses and surface state evaluation methods practicable by an appropriate design modification by one skilled in the art based on the surface state evaluation apparatuses and the surface state evaluation methods described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A surface state evaluation apparatus, comprising:
an imaging unit configured to image a first region and a second region of a surface of a sample, a plurality of liquid droplets being provided in the first region, a plurality of liquid droplets being provided in the second region; and
a processing unit configured to evaluate a state of the surface based on a result of comparing a first image of the first region imaged by the imaging unit and a second image of the second region imaged by the imaging unit.

2. The apparatus according to claim 1, wherein the processing unit is configured to evaluate the state of the surface based on a difference between a density of the liquid droplets in the first image and a density of the liquid droplets in the second image.

3. The apparatus according to claim 1, wherein the processing unit is configured to evaluate the state of the surface based on a difference between a size of the liquid droplets in the first image and a size of the liquid droplets in the second image.

4. The apparatus according to claim 1, wherein the processing unit is configured to evaluate the state of the surface based on a difference between a brightness of at least a portion of the first image and a brightness of at least a portion of the second image.

5. The apparatus according to claim 1, wherein the liquid droplets are formed by a change from a gas to a liquid on the surface.

6. The apparatus according to claim 1, further comprising:
a gas flow supply unit configured to supply a gas flow toward the surface; and
a temperature controller configured to control a temperature of the sample,
the liquid droplets being formed by a change from a gas included in the gas flow to a liquid on the surface.

7. The apparatus according to claim 6, wherein
the gas flow includes a plurality of particles, and
a diameter of each of the particles is not less than 1 nm and not more than 50 nm.

8. The apparatus according to claim 6, wherein the gas flow includes a polyalcohol.

9. The apparatus according to claim 6, wherein the temperature controller causes the surface to be in a vapor-liquid equilibrium state in the imaging.

10. A surface state evaluation apparatus, comprising:
an imaging unit configured to image a sample having a plurality of liquid droplets formed on a surface of the sample; and
a processing unit configured to process an image acquired by the imaging unit,
the processing unit being configured to evaluate a state of the surface of the sample by at least one selected from comparing a density of the liquid droplets in the image to a first threshold, comparing a size of the liquid droplets in the image to a second threshold, and comparing a brightness of the image to a third threshold.

11. A surface state evaluation method, comprising:
imaging a first region and a second region of a surface of a sample, a plurality of liquid droplets being provided in the first region, a plurality of liquid droplets being provided in the second region; and
processing to evaluate a state of the surface based on a result of comparing a first image of the first region imaged in the imaging and a second image of the second region imaged in the imaging.

12. The method according to claim 11, wherein the processing includes evaluating the state of the surface based on a difference between a density of the liquid droplets in the first image and a density of the liquid droplets in the second image.

13. The method according to claim 11, wherein the processing includes evaluating the state of the surface based on a difference between a size of the liquid droplets in the first image and a size of the liquid droplets in the second image.

14. The method according to claim 11, wherein the processing includes evaluating the state of the surface based on a difference between a brightness of at least a portion of the first image and a brightness of at least a portion of the second image.

15. The method according to claim 11, wherein the liquid droplets are formed by a change from a gas to a liquid on the surface.

16. The method according to claim 11, further comprising forming the liquid droplets by a change from a gas included in a gas flow to a liquid on the surface by supplying the gas flow toward the surface while controlling a temperature of the sample.

17. The method according to claim 16, wherein
the gas flow includes a plurality of particles, and
a diameter of each of the particles is not less than 1 nm and not more than 50 nm.

18. The apparatus according to claim 16, wherein the gas flow includes a polyalcohol.

19. The method according to claim 16, wherein the controlling of the temperature includes causing the surface to be in a vapor-liquid equilibrium state.

20. A surface state evaluation method, comprising:
imaging a surface of a sample having a plurality of liquid droplets provided on the surface; and
processing an image imaged by the imaging,
the processing unit being configured to evaluate a state of the surface by at least one selected from comparing a density of the plurality of liquid droplets in the image to a first threshold, comparing a size of the liquid droplets in the image to a second threshold, and comparing a brightness of the image to a third threshold.
